(19) United States
(12) Patent Application Publication
(10) Pub. No.: US 2026/0159028 A1
(43) Pub. Date: Jun. 11, 2026

(54) VEHICLE AND METHOD OF CONTROLLING THE SAME

(71) Applicants: HYUNDAI MOTOR COMPANY, Seoul (KR); KIA CORPORATION, Seoul (KR)

(72) Inventors: Hui XIE, Shandong (CN); Hang Hang WANG, Shandong (CN); Xi Sha LI, Shandong (CN); Kyong Ho SHON, Gyeonggi do (KR); Jin Shun LI, Shandong (CN)

(73) Assignees: HYUNDAI MOTOR COMPANY, Seoul (KR); KIA CORPORATION, Seoul (KR)

(21) Appl. No.: 18/988,017

(22) Filed: Dec. 19, 2024

(30) Foreign Application Priority Data
Dec. 9, 2024 (CN) 202411803042.9

(51) Int. Cl. B60R 25/24; B60R 25/04; G07C 9/00

(52) U.S. Cl. CPC B60R 25/24; B60R 25/04; G07C 9/00309; B60R 2325/101; B60R 2325/205; G07C 2009/00793; G07C 2209/63

(57) ABSTRACT

A vehicle includes at least one processor and a memory configured to store one or more programs executed by the one or more processor, wherein the at least one processor includes a first processing unit configured to search for a second user terminal which is in a registered state and positioned in a second area using a communication device when receiving a vehicle control signal from a first user terminal which is in a connected state and positioned in a first area through the communication device, and a second processing unit configured to obtain information related to the second user terminal positioned in the second area through the communication device and perform personalized linkage of the vehicle using the information related to the second user terminal.

### CROSS-REFERENCE TO RELATED APPLICATION

The present application claims priority to Chinese Patent Application No. 202411803042.9, filed on Dec. 9, 2024, the entire contents of which is incorporated herein for all purposes by this reference.

### BACKGROUND OF THE PRESENT DISCLOSURE

### Field of the Present Disclosure

The present disclosure relates to a vehicle and a method for controlling the same.

### Description of Related Art

A passive-entry-passive-start (PEPS) function can estimate a position of a smartphone through a communication module mounted on a vehicle and then automatically perform operations of door locking/unlocking, starting, and the like of the vehicle.

After entering a Bluetooth connectable area, a vehicle owner establishes a Bluetooth communication channel between a smartphone application and a vehicle and receives the PEPS function according to his or her position.

However, the conventional vehicle cannot provide the PEPS function after being connected to a plurality of smartphones at the same time, and when there is a first connected smartphone, personalized linkage is automatically performed through the corresponding smartphone.

Therefore, when the plurality of smartphones are registered, personalized linkage is performed using the first connected smartphone, and thus there is a problem that a driver cannot automatically perform personalized linkage using a target smartphone.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle and a method for controlling the same, which are configured for performing personalized linkage by automatically recognizing a terminal positioned in a driver seat area.

Furthermore, the present disclosure is directed to providing a vehicle and a method for controlling the same, which are configured for performing personalized linkage through a smartphone adjacent to a driver's seat without disconnecting a currently connected smartphone.

According to an exemplary embodiment of the present disclosure, there is provided a vehicle including at least one processor, and a memory operatively connected to the at least one processor and configured to store one or more programs executed by the one or more processor, wherein the at least one processor includes a first processing unit configured to search for a second user terminal which is in a registered state and positioned in a second area using a communication device when receiving a vehicle control signal from a first user terminal which is in a connected state and positioned in a first area through the communication device, and a second processing unit configured to obtain information related to the second user terminal positioned in the second area through the communication device and perform personalized linkage of the vehicle based on the information related to the second user terminal.

The second processing unit may perform the personalized linkage of the vehicle based on the first user terminal when the second processing unit does not find a user terminal in the second area.

The first area may include a wider radius range than the second area centered on the vehicle.

The first area may be a passive entry operable area, and the second area may be an area within less than or equal to a predetermined distance which is set in advance with respect to a driver's seat.

The vehicle may further include a third processing unit configured to control an operation of the vehicle according to the vehicle control signal received from the first user terminal, wherein the vehicle control signal may include a door control signal and a starting control signal.

The second processing unit may perform personalized linkage of the vehicle through the second user terminal after the third processing unit unlocks a door of the vehicle according to the vehicle control signal.

When the second user terminal in the registered state is found in the second area, the second processing unit may transmit a personalized linkage request message based on the second user terminal to the first user terminal through the communication device.

The second processing unit may perform personalized linkage of the vehicle through the second user terminal when receiving a personalized linkage permission message from the first user terminal.

When the second user terminal positioned in the second area is provided as a plurality of second user terminals, the second processing unit may select a second user terminal for personalized linkage according to a preset priority and perform personalized linkage of the vehicle.

The second processing unit may sequentially transmit a personalized linkage request message based on the second user terminal to the first user terminal according to an order of the priority through the communication device.

When receiving a personalized linkage permission message from the first user terminal, the second processing unit may stop transmission of the personalized linkage request message.

The second processing unit may initialize personalized linkage settings when the vehicle is turned off after performing personalized linkage of the vehicle through the second user terminal.

According to an exemplary embodiment of the present disclosure, there is provided a method for controlling a vehicle which is performed by a computing device including at least one processor and a memory operatively connected to the at least one processor and configured to store one or more programs executed by the at least one processor, which includes, by the processor, receiving a vehicle control signal from a first user terminal which is in a connected state and positioned in a first area through a communication device, searching for a second user terminal which is in a registered state and positioned in a second area using the communication device, obtaining information related to the second user terminal positioned in the second area through the communication device, and performing personalized linkage of the vehicle based on the information related to the second user terminal.

The method may further include, after searching for the second user terminal, performing personalized linkage of the vehicle based on the first user terminal when a user terminal is not found in the second area.

The method may further include, before the performing of the personalized linkage of the vehicle, controlling an operation of the vehicle according to the vehicle control signal received from the first user terminal.

The controlling of the operation of the vehicle may include controlling a door of the vehicle to be unlocked according to the vehicle control signal.

The method may include, before the performing of the personalized linkage of the vehicle, transmitting a personalized linkage request message based on the second user terminal to the first user terminal through the communication device.

The performing of the personalized linkage of the vehicle may include receiving a personalized linkage permission message from the first user terminal through the communication device and performing personalized linkage of the vehicle through the second user terminal according to the personalized linkage permission message.

According to an exemplary embodiment of the present disclosure, there is provided a method for controlling a vehicle which is performed by a computing device including at least one processor and a memory operatively connected to the at least one processor and configured to store one or more programs executed by the at least one processor, which includes, by the processor, receiving a vehicle control signal from a first user terminal which is in a connected state and positioned in a first area through a communication device, searching for a plurality of second user terminals that are in a registered state and positioned in a second area using the communication device, selecting a second user terminal for personalized linkage among the plurality of second user terminals according to a preset priority, obtaining information related to the selected second user terminal through the communication device, and performing the personalized linkage of the vehicle based on the information related to the second user terminal.

The method may include, before the performing of the personalized linkage of the vehicle, sequentially transmitting a personalized linkage request message based on the selected second user terminal to the first user terminal through the communication device and performing personalized linkage of the vehicle through a corresponding second user terminal when receiving a personalized linkage permission message from the first user terminal.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view for describing a vehicle according to an exemplary embodiment of the present disclosure;

FIG. 2 is a block diagram illustrating a configuration of the vehicle according to the embodiment;

FIG. 3 is a block diagram illustrating a configuration of a user terminal according to the embodiment;

FIG. 4 is a view for describing the operation of the vehicle according to the embodiment;

FIG. 5 and FIG. 6 are views for describing the operation of a first processing unit according to the embodiment;

FIG. 7 is a view for describing the operation of a vehicle according to another exemplary embodiment of the present disclosure; and

FIG. 8, FIG. 9, FIG. 10 and FIG. 11 are flowcharts illustrating methods of controlling a vehicle according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings.

However, the technical spirit of the present disclosure is not limited to some of the described embodiments, but may be implemented in various different forms, and at least one of the components among the exemplary embodiments of the present disclosure may be used by being selectively coupled or substituted without departing from the scope of the technical spirit of the present disclosure.

Furthermore, terms (including technical and scientific terms) used in embodiments of the present disclosure may be construed as meaning which may be generally understood by those skilled in the art to which an exemplary embodiment of the present disclosure pertains unless explicitly specifically defined and described, and the meanings of the commonly used terms, such as terms defined in a dictionary, may be construed in consideration of contextual meanings of related technologies.

Furthermore, the terms used in the exemplary embodiments of the present disclosure are for describing the exemplary embodiments and are not intended to limit the present disclosure.

In the specification, a singular form may include a plural form unless otherwise specified in the phrase, and when referred to as “at least one (or one or more) of A, B, and C,” one or more among all possible combinations of A, B, and C may be included.

Furthermore, terms such as first, second, A, B, (a), and (b) may be used to describe components of the exemplary embodiments of the present disclosure.

These terms are only for distinguishing one component from another component, and the nature, sequence, order, or the like of the corresponding components is not limited by these terms.

Furthermore, when a first component is referred to as being “connected,” “coupled,” or “joined” to a second component, it may include a case in which the first component is directly connected, coupled, or joined to the second component, but also a case in which the first component is “connected,” “coupled,” or “joined” to the second component by other components present between the first component and the second component.

Furthermore, when the first component is referred to as being formed or disposed on “on (above) or below (under)” the second component, “on (above)” or “below (under)” may include not only a case in which two components are in direct contact with each other, but also a case in which one or more third components are formed or disposed between the two components. Furthermore, when referred to as “on (above) or below (under),” it may include the meaning of not only an upward direction but also a downward direction based on one component.

Hereinafter, various exemplary embodiments will be described in detail with reference to the accompanying drawings, and the same or corresponding components are denoted by the same reference numeral regardless of the reference numerals, and overlapping descriptions thereof will be omitted.

For purposes of The present application and the claims, using the exemplary phrase “at least one of: A; B; or C” or “at least one of A, B, or C,” the phrase means “at least one A, or at least one B, or at least one C, or any combination of at least one A, at least one B, and at least one C. Furthermore, exemplary phrases, such as “A, B, and C”, “A, B, or C”, “at least one of A, B, and C”, “at least one of A, B, or C”, etc. As used herein may mean each listed item or all possible combinations of the listed items. For example, “at least one of A or B” may refer to (1) at least one A; (2) at least one B; or (3) at least one A and at least one B.

Throughout the present disclosure, references to components, units, or modules generally refer to items that logically may be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

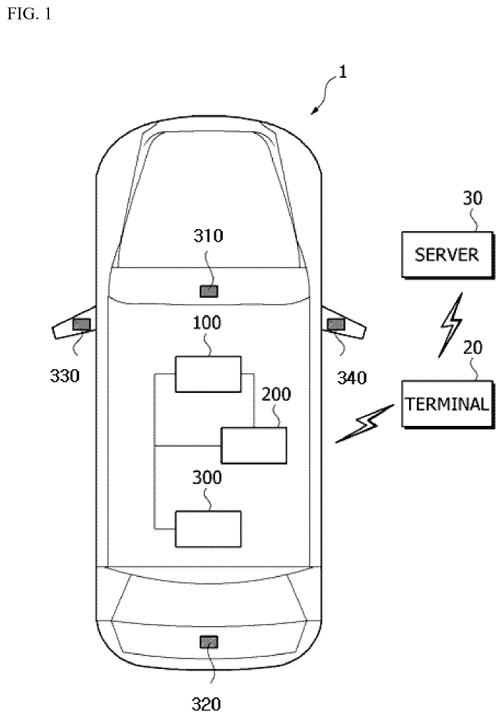

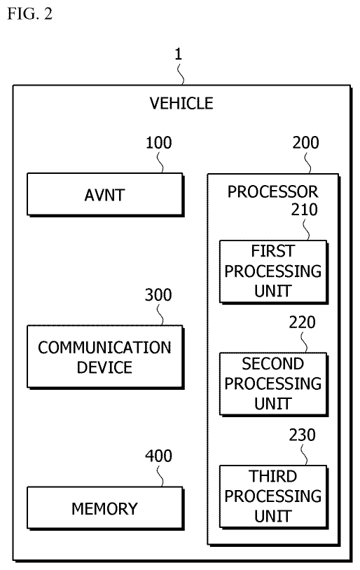

FIG. 1 is a view for describing a vehicle according to an exemplary embodiment of the present disclosure, and FIG. 2 is a block diagram illustrating a configuration of the vehicle according to the exemplary embodiment of the present disclosure. Referring to FIG. 1 and FIG. 2, a vehicle 1 according to the exemplary embodiment of the present disclosure may include an audio video navigation and telematics (AVNT) 100, a processor 200, a communication device 300, and a memory 400.

The vehicle 1 may include the AVNT 100 which is provided in a center fascia and is configured to control an audio device, an air conditioner, a Bluetooth device, a seat heater, and the like.

An input device for receiving a user input may be disposed in the center fascia or the AVNT 100, and a display device for displaying operation information for at least one of functions performed in the vehicle 1 may be disposed.

The input device may include hardware devices such as various buttons or switches, pedals, a keyboard, a mouse, a track-ball, various levers, a handle, a stick, etc.

Furthermore, the input device may include a graphical user interface (GUI), that is, a software device, such as a touch pad. The touch pad may be implemented as a touch screen panel (TSP) to form a mutual layer structure with a display panel of the display device.

The display device may function as a user interface. The display device may display the vehicle's operating state, control state, route/traffic information, energy remaining information, content requested by a driver, and the like by a processor. Furthermore, the display device may be formed as a touch screen configured for detecting a driver input to receive the driver's request that instructs the processor.

The internal portion of a vehicle body may include a keyway into which a fob type or card type remote controller may be inserted. Here, the keyway may be provided on a dashboard or center fascia and provided at a position adjacent to a driver's seat.

The vehicle 1 may transmit and receive information with a remote controller or a terminal when the remote controller is inserted into the keyway or when authentication with the remote controller or terminal is completed via a wireless communication network.

The internal part of the vehicle body may further include a start button that receives turn-on/off commands. Therefore, the vehicle starts when the start button is pressed by the user after the authentication with the remote controller or terminal is completed.

The vehicle 1 may further include a communication device for transmitting and receiving information with at least one of electronic devices and a terminal 20 that are provided in the vehicle.

The communication device 300 may include one or more components for enabling communication between in-vehicle components, and for example, may include at least one of a short-range communication module, a wired communication module, and a wireless communication module.

Furthermore, the communication device 300 may include at least one of the wired communication module and the wireless communication module for communication with the user terminal 20 and a server 30.

For example, the short-range communication module may include various short-range communication modules for transmitting and receiving signals using a wireless communication network at a short distance, such as a Bluetooth module, an infrared communication module, a radio frequency (RF) identification communication module, a wireless local access network (WLAN) communication module, a near-field communication (NFC) communication module, or a ZigBee communication module.

For example, the wired communication module may include not only various wired communication modules such as a Controller Area Network (CAN) communication module, a Local Area Network (LAN) module, a wide area network (WAN) module, a value added network (VAN) module, etc., but also various cable communication modules such as a universal serial bus (USB), a high definition multimedia interface (HDMI), a digital visual interface (DVI), a recommended standard 232 (RS-232), power line communication, plain old telephone service (POTS), etc.

For example, a Controller Area Network (CAN) may include a communication protocol designed for real-time data exchange between microcontrollers and devices within vehicles and industrial systems. CAN may allow multiple electronic control units to communicate with each other without the demand for a host computer, making it useful for applications where reliable, high-speed communication is predetermined.

For example, a value added network (VAN) may include a private network which may provide businesses with secure, reliable communication channels for exchanging data and documents. VANs may offer services (e.g., data encryption, format translation, message routing, or tracking, etc.) to ensure that business documents (e.g., invoices, purchase orders, or shipping notices, etc.) may be transmitted efficiently and/or securely between trading partners.

The wired communication module may further include a Local Interconnect Network (LIN). For example, a Local Interconnect Network (LIN) may include a low-cost serial communication protocol which may be used in automotive systems to connect electronic components (e.g., sensors, actuators, or control units, etc.). For example, for simplicity and/or cost-efficiency, LIN may manage functions that do not require high-speed data transfer (e.g., window controls, seat adjustments, lighting, or climate control, etc.). LIN may function on a single-master, multiple-slave architecture, where one master node may coordinate communication with multiple slave nodes.

Furthermore, in addition to the Wi-Fi module and the Wireless Broadband (WiBro) module, the wireless communication module may include a wireless communication module for supporting various wireless communication methods, such as Global System for Mobile communication (GSM), Code Division Multiple Access (CDMA), Wideband Code Division Multiple Access (WCDMA), Universal Mobile Telecommunications System (UMTS), Time Division Multiple Access (TDMA), and Long Term Evolution (LTE).

The user terminal 20 communicates with the vehicle 1, receives at least one of a vehicle door lock and unlock command, a tailgate lock and unlock command, a start command, a lamp lighting command, and a start command as a user input, and transmits information corresponding to the received command to the vehicle. The user terminal 20 may transmit the information corresponding to the received command to the vehicle as a communication signal.

The user terminal 20 may be implemented as a computer or portable terminal which may be communicatively connected to the vehicle via a network.

Here, the computer may include, for example, a notebook, desktop, laptop, tablet PC, slate PC, or the like which is provided with a WEB browser, and the portable terminal is a wireless communication device that ensures portability and mobility and may include, for example, various kinds of handheld-based wireless communication devices such as a personal communication system (PCS), a GSM, a personal digital cellular (PDC), a personal handyphone system (PHS), a personal digital assistant (PDA), an international mobile telecommunication (IMT)-2000, CDMA-2000, WCDMA, and a wireless broadband Internet (WiBro) terminal, a smartphone, etc., and wearable devices such as a watch, a ring, a bracelet, an anklet, a necklace, glasses, contact lenses, a head-mounted-device (HMD), etc.

In an exemplary embodiment of the present disclosure, the user terminal 20 may communicate with the vehicle through a Bluetooth low energy (BLE) communication method. The user terminal 20 may perform communication based on the Bluetooth beacon standard (iBeacon).

The AVNT 100 is referred to as an information and entertainment system in a vehicle and may be a system that integrates navigation, audio, video, and communication functions. The AVNT 100 may output a message generated by the processor 200 in at least one of a visual manner, an audible manner, and a combination thereof.

The AVNT 100, the processor 200, and the communication device 300 may be implemented as one module, but in the exemplary embodiment of the present disclosure, will be described separately for convenience of description.

The AVNT 100 may be a component for providing a hardware interface integrated into the system in the vehicle. The AVNT 100 may perform system control for a screen, buttons, and various integrated information and entertainment functions.

The AVNT 100 may be provided at the center or console of the vehicle dashboard to provide vehicle information and an entertainment interface. The information and entertainment system may include AM/FM radio, satellite radio, DVDs/CDs, cassette tapes, USB MP3, dashcams, Global Positioning System (GPS) navigation devices, Bluetooth, Wi-Fi, etc., and also provide the state information of the vehicle system. Furthermore, the AVNT 100 may perform functions such as voice control and motion recognition.

The processor 200 may be configured for controlling the vehicle body such as a vehicle, doors, windows, or keys (a digital key, a smartphone key, and a fob). The processor is configured to perform a body control function (BCM), a smart key entry/start function (SMK), a tire air pressure monitoring function (TPMS), an immobilizer function (IMMO), digital key authentication (IAU), an autonomous parking related control function (PDW), etc. For example, the processor 200 may be a body domain controller (BDC), but is not limited thereto, and may be used to encompass a platform controller for providing electronic convenience functions to a body domain area.

The communication device 300 may perform pairing between the user terminal 20 and the vehicle 1 using a Bluetooth signal.

The communication device 300 may include a transceiver for transmitting and receiving information using an antenna, a communication circuit, a communication processor, and the like and perform short-range communication with the user terminal 20. According to an exemplary embodiment of the present disclosure, the communication device 300 may perform Bluetooth communication, NFC communication, or ultra-wideband (UWB) communication. The communication device 300 may be provided adjacent to a door handle of the vehicle 1 to request authentication information when it is determined that the user terminal approaches within a predetermined distance.

In the Bluetooth standard, Bluetooth 1.0 stipulates that a data transmission rate is 1 Mbps and a transmission distance ranges from 10 to 100 m, and communication is possible even in the presence of obstacles because Bluetooth 1.0 utilizes a high radio frequency of 2.4 GHz.

When the user terminal including a digital key approaches the outside of the vehicle 1, the communication device 300 according to the exemplary embodiment of the present disclosure may measure the position of the user terminal, unlock the vehicle door according to a positioning result, and control the remote start of the vehicle 1 to be performed under the control of the processor 200.

The communication device 300 may include a plurality of positioning modules 310 to 340. The positioning modules 310 to 340 may be short-range wireless communication modules, and each wireless communication module may measure the strength of a wireless signal received from the user terminal. One of the plurality of wireless communication modules mounted in the vehicle 1 may be set as a master module. The master module may collect the strength of a wireless signal measured by another wireless communication module and transmit the strength to the processor.

For example, the positioning modules 310 to 340 may include a Bluetooth module, a BLE module, a Wi-Fi module, etc. The positioning modules 310 to 340 may include an FRT(Front) antenna provided at a front portion of the vehicle 1 and mounted in the AVNT, an RR(Rear) antenna provided at a rear portion of the vehicle and mounted on a shark antenna, an LH(Left Hand) antenna mounted in a left O/S(Off-Side) mirror, and an RH(Right Hand) antenna mounted in a right O/S mirror. A wireless signal strength of the user terminal 20 may be independently measured and transmitted to a master module.

The processor 200 may perform the overall control of the vehicle 1. The processor 200 may be configured to execute applications and instructions that are stored in the memory 400.

The processor 200 may be a main CPU for overall control of a vehicle control system 10. In an exemplary embodiment of the present disclosure, the processor 200 may perform a pairing operation by executing a Bluetooth application to perform communication between the Bluetooth application and the communication device.

The processor 200 may be configured to determine a relative position of the user terminal 20 with respect to the vehicle 1. In an exemplary embodiment of the present disclosure, the relative position may include a distance between the vehicle 1 and the user terminal 20 and a direction in which the user terminal 20 is positioned with respect to the vehicle 1.

For example, the processor 200 may be configured to determine the relative position using at least one of the Wi-Fi, Bluetooth, and BLE methods.

The processor 200 may compare the positioning results using Wi-Fi, digital key BLE, and UWB with a preset matching table and determine the relative position of the user terminal 20. The matching table may include recorded data that stores positioning results in a state in which the user terminal 20 is positioned inside the vehicle 1 and results obtained by separately experimenting the positioning results in the state in which the user terminal 20 is positioned inside the vehicle 1 according to each positioning method. The matching table may be stored in the memory 400.

For example, the processor 200 may be configured to determine the relative position between the vehicle and the user terminal through at least one UWB positioning method among a time of flight (TOF) method of determining a distance by measuring the time it takes for a signal to move from a transmitter to a receiver, a two-way ranging (TWR) method of determining a distance by measuring the round-trip time between a transmitter and a receiver, and an angle of arrival (AOA) method of determining a position by measuring an angle at which the signal reaches the receiver.

Alternatively, the processor 200 may be configured to determine the relative position between the vehicle and the user terminal through at least one Wi-Fi positioning method among a received signal strength indicator (RSSI) method of estimating a distance by measuring the strength of a Wi-Fi signal, the TOF method of determining a distance by measuring the time it takes for the signal to travel from a transmitter to a receiver, and a fingerprinting method of previously measuring a Wi-Fi signal strength profile (fingerprint) at a specific position to build a database and estimating a position by comparing the above profile with a currently measured signal strength.

Alternatively, the processor 200 may be configured to determine the relative position between the vehicle and the user terminal through at least one Bluetooth positioning method among the RSSI method of estimating a distance by measuring the strength of a BLE signal, the AOA method of determining the position by measuring the angle at which the signal reaches the receiver, and the fingerprinting method of previously measuring a BLE signal strength profile (fingerprint) at a specific position to build a database and estimating a position by comparing the above profile with a currently measured signal strength.

The memory 400 may store an application and various pieces of data for controlling the vehicle 1 and load the application or read or write the data at the request of the processor 200.

The memory 400 may store at least one algorithm that is configured to perform determination or execution of various commands for the operation of the vehicle control system 10 according to the exemplary embodiment of the present disclosure. The memory 400 may include at least one storage medium of a flash memory, a hard disc, a memory card, a read-only memory (ROM), a random access memory (RAM), an electrically erasable programmable ROM (EEPROM), a programmable ROM (PROM), a magnetic memory, a magnetic disc, and an optical disc.

In the following embodiments, an example in which positioning is performed using a Bluetooth signal and a passive-entry-passive-start (PEPS) operation is controlled will be described.

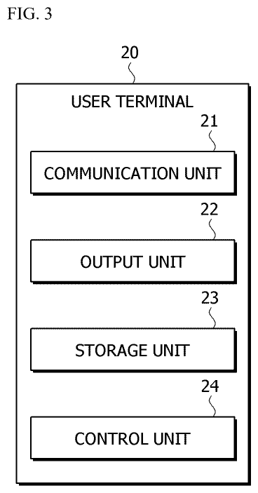

FIG. 3 is a block diagram illustrating a configuration of a user terminal according to the exemplary embodiment of the present disclosure.

Referring to FIG. 3, the user terminal 20 may include a communication unit 21, an output unit 22, a storage unit 23, and a control unit 24.

The user terminal 20 may include a smartphone, a smart pad, a notebook computer, and the like that the user can carry. The user terminal 20 may store a digital key that generates authentication information for controlling functions such as locking and unlocking of the vehicle door, remote starting, emergency alarm, and trunk opening.

The communication unit 21 may include a transceiver for transmitting and receiving information using an antenna, a communication circuit, a communication processor, etc., and perform short-range communication with the vehicle. According to an exemplary embodiment of the present disclosure, the communication unit 21 may perform NFC communication or UWB communication.

The output unit 22 may output information stored in the user terminal 20 in at least one of a visual manner, an audible manner, and a combination thereof. According to an exemplary embodiment of the present disclosure, the output unit 22 may be implemented as a display device that adopts a liquid crystal display (LCD) panel, a light emitting diode (LED) panel, an organic light emitting diode (OLED) panel, a plasma display panel (PDP), etc. The LCD may include a thin film transistor LCD (TFT-LCD). The output unit 22 may be implemented to be formed integrally with the input unit by a touch screen panel (TSP).

The storage unit 23 may store at least one algorithm that is configured to perform determination or execution of various commands for the operation of the user terminal 20 according to various exemplary embodiments of the present disclosure. The storage unit 23 may include at least one storage medium of a flash memory, a hard disc, a memory card, a ROM, a RAM, an EEPROM, a PROM, a magnetic memory, a magnetic disc, an optical disc, etc. The storage unit 23 may store driver information for a plurality of vehicles.

The control unit 24 may be implemented by various processing devices such as a microprocessor including a semiconductor chip configured for performing determinations or executions of various commands embedded therein and may be configured for controlling the operation of the user terminal 20 according to the exemplary embodiment of the present disclosure. The control unit 24 may be electrically connected to the communication unit 21, the output unit 22, and the storage unit 23 through a wired cable or various circuits to transmit electrical signals including control commands and the like and may transmit and receive electrical signals including control commands and the like by various wireless communication networks such as a CAN.

In the vehicle control system 10 according to the exemplary embodiment of the present disclosure, the user terminal 20 may operate as a digital key. Hereinafter, the digital key and the user terminal may be used as terms referring to the same component.

The digital key 20 may open or close the door provided in the vehicle 1, turn on or off the vehicle 1, and execute various functions included in the vehicle 1 as needed. The digital key 20 may be a device which may use at least one of low-power Bluetooth (BLE) communication and NFC.

One digital key 20 may operate after linked to a specific vehicle 1, and as needed, a plurality of digital keys 20 may be linked to one vehicle 1 or one digital key 20 may be linked to a plurality of vehicles 1. Furthermore, there may be a case in which a plurality of digital keys 20 are linked to a plurality of vehicles 1.

However, the vehicle 1 may operate after being connected to only one digital key 20 at the same time, and to be linked to another digital key 20, the vehicle 1 needs to disconnect the currently connected digital key 20 and establish new connection.

Furthermore, the digital key 20 may be provided and operated in a device such as a smartphone, and there may be a case in which a plurality of digital keys 20 are provided in one smartphone. Although the exemplary embodiment describes an example in which the digital key 20 is provided and operated in the smartphone, the present disclosure is not limited thereto, and as needed, the digital key 20 may be provided in a device other than the smartphone.

The digital key 20 may be configured for controlling the vehicle 1, and to the present end, may communicate with the vehicle 1 through Bluetooth Low Energy (BLE) communication, Ultra-Wideband (UWB) communication, wireless Internet network communication, or mobile communication network communication.

The digital key 20 may be manipulated by the user to perform various functions for controlling the vehicle 1 and manipulated to set one or more wireless anchors.

The digital key 20 may search for nearby wireless anchors and register the found wireless anchors. That is, the digital key 20 may use various communication methods to search for wireless anchors which may be communicatively connected in a wireless communication manner. For example, when two wireless anchors are positioned adjacent to the digital key 20, one wireless anchor may perform communication through BLE communication, and the other may perform communication through wireless Internet network communication, the digital key 20 may be communicatively connected to one of the two wireless anchors or communicatively connected to both wireless anchors.

In an exemplary embodiment of the present disclosure, the wireless anchor may be the same component as the positioning module.

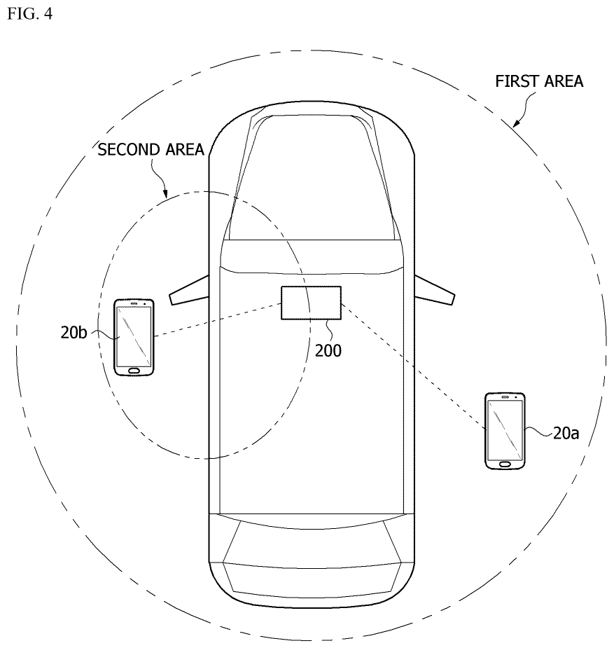

FIG. 4 is a view for describing the operation of the vehicle according to the exemplary embodiment of the present disclosure. Referring to FIG. 4 together, when receiving a vehicle control signal from a first user terminal 20a which is in a connected state and positioned in a first area through a communication device, a first processing unit 210 may search for a second user terminal 20b which is in a registered state and positioned in a second area using the communication device.

In an exemplary embodiment of the present disclosure, the first user terminal 20a and the second user terminal 20b may include the same configuration as the user terminal of FIG. 3.

In the exemplary embodiment of the present disclosure, the first area may include a wider radius range than the second area centered on the vehicle. The second area may include a range included in the first area, for example, the first area may be a passive entry operable area, and the second area may be an area within less than a predetermined distance which is set in advance with respect to a driver's seat. The first area may include a radius range of about 0.8 meters to 6 meters centered on the vehicle, and the second area may include a radius range which is set in advance with respect to the driver's seat of the vehicle.

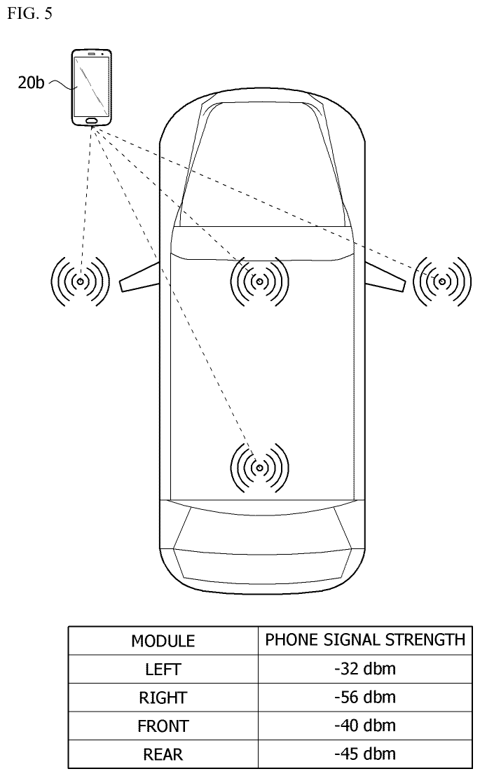

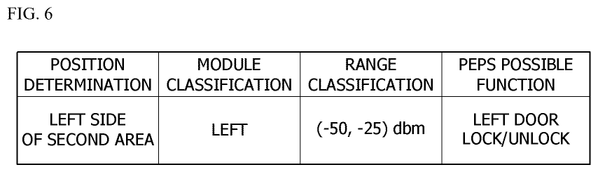

FIG. 5 and FIG. 6 are views for describing an operation of a first processing unit according to the exemplary embodiment of the present disclosure. Referring to FIG. 5, the Bluetooth signal strength of the second user terminal 20b was measured as −32 dbm, −56 dbm, −40 dbm, and −45 dbm through left, right, front, and rear positioning modules, respectively. The first processing unit 210 is configured to determine that the second user terminal is positioned in the second area when the Bluetooth signal strength measured from the left positioning module ranges from −50 dbm to −25 dbm as shown in FIG. 6. Therefore, the first processing unit may be configured to determine that the second user terminal 20b found through FIG. 5 is positioned in the second area.

The vehicle control signal may be a Bluetooth signal of the first user terminal 20a measured through the positioning module of the communication device, and as will be described below, the PEPS function is provided using the Bluetooth signal strength of the first user terminal 20a.

The first processing unit 210 may analyze the Bluetooth signal strength of the first user terminal 20a measured through the positioning modules of the communication device, and when it is determined that the first user terminal 20a has entered a passive entry area, the first processing unit 210 may search for the second user terminal 20b registered in the second area using the positioning modules. The first processing unit 210 may be configured for controlling the positioning modules to search for the second user terminal 20b previously registered other than the first user terminal 20a. When the second user terminal 20b previously registered other than the first user terminal 20a is found, the first processing unit 210 may be configured to determine whether the second user terminal 20b is positioned in the second area using the Bluetooth signal strength received from the second user terminal 20b.

The second processing unit 220 may obtain information related to the second user terminal 20b positioned in the second area through the communication device and perform personalized linkage of the vehicle based on the information related to the second user terminal 20b.

In an exemplary embodiment of the present disclosure, personalized linkage may be a process of automatically controlling functions such as a vehicle seat position, a position and angle of an operating system (OS) mirror, the ON/OFF setting of convenience functions, radio/Digital Multimedia Broadcasting (DMB) broadcast channels, and the media volume setting according to the individuals' registered settings.

When it is determined that the second user terminal 20b is positioned in the second area, the second processing unit 220 may load personalized linkage information corresponding to information obtained from the second user terminal 20b using the above information and automatically control functions such as the vehicle seat position, the position and angle of the OS mirror, the ON/OFF setting of the convenience functions, the radio/DMB broadcast channels, and the media volume setting according to the individuals' registered settings.

In the instant case, the second processing unit 220 may perform personalized linkage of the vehicle through the second user terminal 20b after a third processing unit 230 unlocks the vehicle door according to the vehicle control signal. That is, the second processing unit 220 may perform personalized linkage based on the second user terminal 20b without disconnecting the first user terminal 20a in the connected state and vehicle. That is, the second processing unit 220 obtains information from the second user terminal 20b to perform personalized linkage and measures the Bluetooth signal strength of the first user terminal 20a to provide the PEPS function.

When the second processing unit 220 does not find a user terminal in the second area, the second processing unit 220 may perform personalized linkage of the vehicle based on the first user terminal 20a. The second processing unit 220 may perform the personalized linkage of the vehicle by obtaining information from the first user terminal 20a when, after receiving the vehicle control signal from the first user terminal 20a, no other terminal is found within a predetermined time period, when the found terminal is not positioned in the second area, or when the found terminal is not registered.

When the second processing unit 220 in the registered state is found in the second area, the second processing unit 220 may transmit a personalized linkage request message based on the second user terminal 20b toward the first user terminal 20a through the communication device.

When receiving a personalized linkage permission message from the first user terminal 20a, the second processing unit 220 may perform personalized linkage of the vehicle through the second user terminal 20b.

That is, when the second user terminal 20b is found in the second area, the second processing unit 220 is configured to perform personalized linkage based on the second user terminal 20b only when receiving an acknowledge message from the first user terminal 20a. At the instant time, when the second processing unit 220 does not receive the personalized linkage permission message from the first user terminal 20a, the second processing unit 220 may perform the personalized linkage of the vehicle based on the first user terminal 20a.

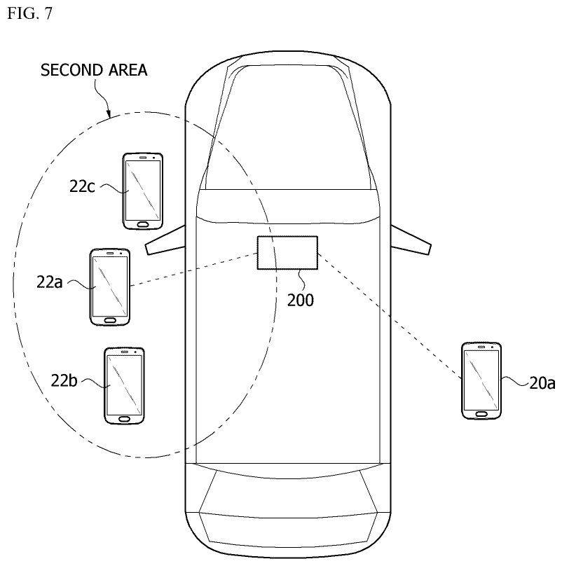

FIG. 7 is a view for describing an operation of a vehicle according to another exemplary embodiment of the present disclosure. Referring to FIG. 7, when a plurality of second user terminals 22a, 22b and 22c positioned in the second area are present, the second processing unit 220 may select the second user terminal 22a for personalized linkage according to a preset priority and perform the personalized linkage of the vehicle. The preset priority may be information which is set in advance by a driver or a vehicle user, matched with terminal information, and stored in the memory in a form of a table. When the plurality of second user terminals 22a, 22b and 22c positioned in the second area are present, the second processing unit 220 may perform the personalized linkage of the vehicle based on the second user terminal 22a with the highest preset priority.

Alternatively, when the plurality of second user terminals 22a, 22b and 22c positioned in the second area are present, the second processing unit 220 may select the second user terminal 22a for personalized linkage according to the registration order and perform the personalized linkage of the vehicle. When the priority is not set, the second processing unit 220 may perform the personalized linkage of the vehicle based on the second user terminal 22a with the order of earliest registration.

Alternatively, when the plurality of second user terminals 22a, 22b and 22c positioned in the second area are present, the second processing unit 220 may select the second user terminal 22a closest to the driver's seat and perform the personalized linkage of the vehicle. When the priority is not set, the second processing unit 220 may analyze the Bluetooth signal strengths received from the plurality of second user terminals 22a, 22b and 22c to estimate the position and perform the personalized linkage of the vehicle based on the second user terminal 22a of which estimated position is determined to be closest to the driver's seat.

Alternatively, the second processing unit 220 may sequentially transmit personalized linkage request messages based on the second user terminals 22a, 22b and 22c to the first user terminal 20a in order of the priority through the communication device.

When receiving the personalized linkage permission message from the first user terminal 20a, the second processing unit 220 may stop transmission of the personalized linkage request message.

When the plurality of second user terminals 22a, 22b and 22c positioned in the second area are present, the second processing unit 220 may transmit the personalized linkage request message for the second user terminal 22a with the highest preset priority to the first user terminal 20a. When receiving the personalized linkage permission message from the first user terminal 20a, the second processing unit 220 may stop transmission of the personalized linkage request message and perform personalized linkage based on the second user terminal 22a with the highest priority.

When the second processing unit 220 does not receive the personalized linkage permission message from the first user terminal 20a, the second processing unit 220 may transmit the personalized linkage request message for the second user terminal 22b with the second highest priority to the first user terminal 20a. When receiving the personalized linkage permission message from the first user terminal 20a, the second processing unit 220 may stop transmission of the personalized linkage request message and perform personalized linkage based on the second user terminal 22b with the second highest priority.

The second processing unit 220 repeats the above process to sequentially transmit personalized linkage request messages according to priority. When the second processing unit 220 does not receive the personalized linkage permission message for the second user terminal 22c with the lowest priority, the second processing unit 220 may perform personalized linkage based on the first user terminal 20a.

Alternatively, when the plurality of second user terminals 22a, 22b and 22c positioned in the second area are present, the second processing unit 220 may sequentially transmit the personalized linkage request message based on the second user terminal 22a to the first user terminal 20a according to the registration order. When receiving the personalized linkage permission message from the first user terminal 20a, the second processing unit 220 may stop transmission of the personalized linkage request message and perform personalized linkage based on the second user terminal 22a with the order of earliest registration.

The second processing unit 220 repeats the above process to sequentially transmit personalized linkage request messages according to the registration order. When the second processing unit 220 does not receive the personalized linkage permission message for the second user terminal 22c with the latest registration order, the second processing unit 220 may perform personalized linkage based on the first user terminal 20a.

Alternatively, when the plurality of second user terminals 22a, 22b and 22c positioned in the second area are present, the second processing unit 220 may sequentially transmit the personalized linkage request message based on the second user terminal 22a to the first user terminal 20a which is closest to the driver's seat. When receiving the personalized linkage permission message from the first user terminal 20a, the second processing unit 220 may stop transmission of the personalized linkage request message and perform personalized linkage based on the second user terminal 22a which is closest to the driver's seat.

The second processing unit 220 repeats the above process to sequentially transmit personalized linkage request messages according to the order of proximity to the driver's seat. When the second processing unit 220 does not receive the personalized linkage permission message for the second user terminal 22c which is the farthest from the driver's seat, the second processing unit 220 may perform personalized linkage based on the first user terminal 20a.

When the vehicle is turned off after performing the personalized linkage of the vehicle through the second user terminal 20b, the second processing unit 220 may initialize personalized linkage settings. When receiving a vehicle off signal, the second processing unit 220 may output a control signal so that the state of the vehicle is changed to a state before the personalized linkage of the vehicle for the second user terminal 20b.

The third processing unit 230 may be configured for controlling the operation of the vehicle according to the vehicle control signal received from the first user terminal 20a.

The vehicle control signal may include a PEPS signal which is a door control signal and a starting control signal. The third processing unit 230 may estimate the position of the first user terminal 20a through the communication modules mounted on the vehicle and then provide the PEPS function that automatically is configured to perform operations such as door lock/unlock and vehicle starting. For example, the third processing unit 230 may estimate the relative position of the first user terminal 20a with respect to the vehicle using the signal strength of the Bluetooth signal received from the first user terminal 20a connected to the Bluetooth module. The third processing unit 230 may provide a passive entry function when the estimated position of the first user terminal 20a is adjacent to the vehicle and provide a passive start function when the estimated position of the user terminal is inside the vehicle.

For convenience, one or more figures are described by way of an example in which the steps are performed by a processor circuit. One, some, or all steps of the example method of a figure, or portions thereof, may be performed by one or more other circuits. One or some, steps of the example method of a figure may be omitted, performed in other orders, and/or otherwise modified, and/or one or more additional steps may be added.

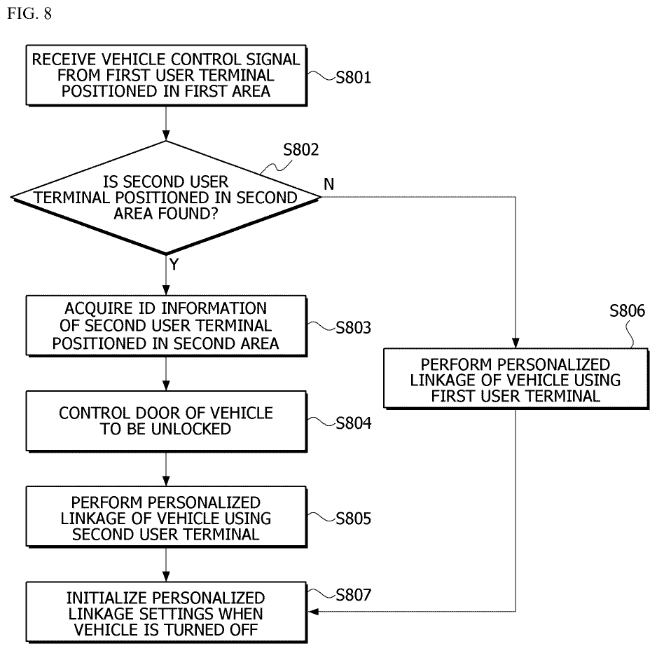

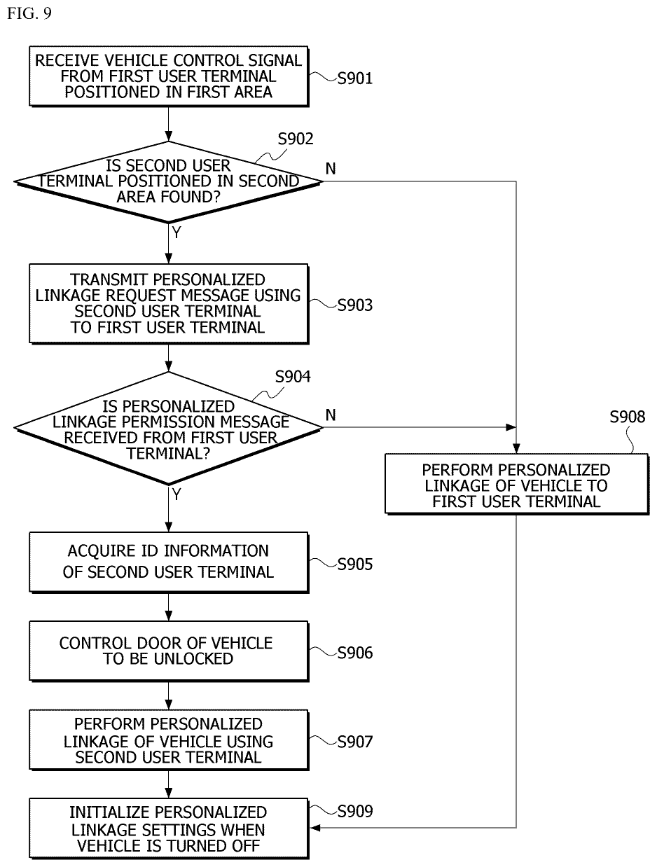

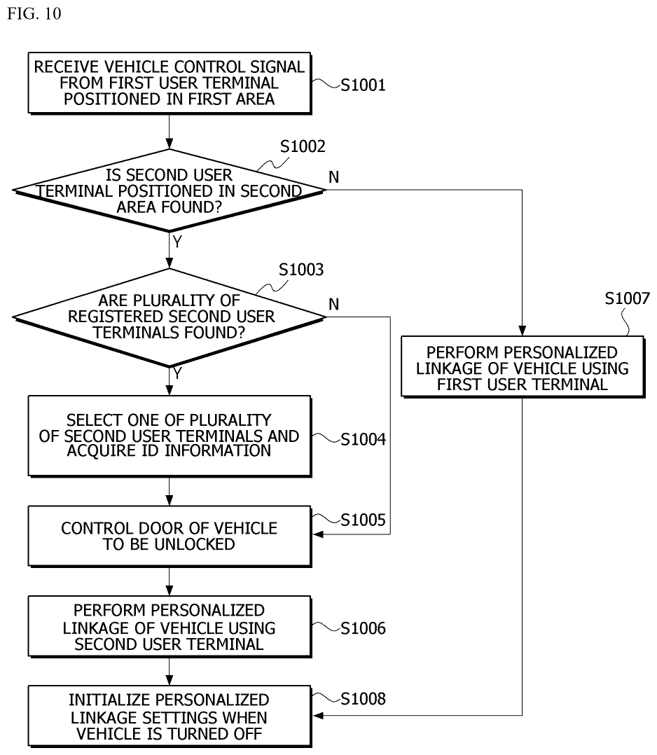

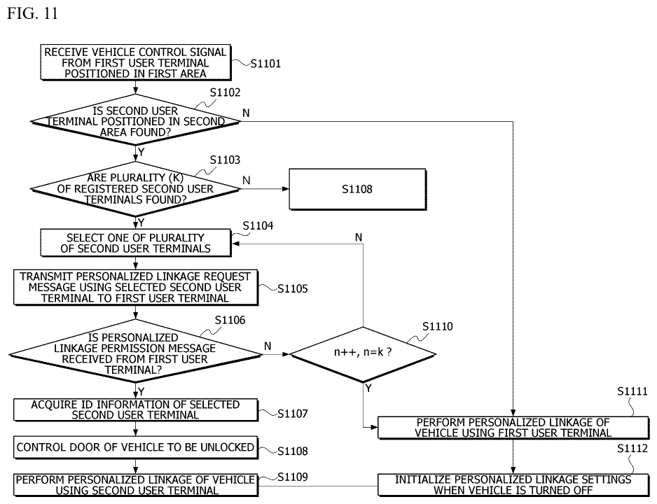

FIG. 8 is a flowchart illustrating a method for controlling a vehicle according to an exemplary embodiment of the present disclosure. Referring to FIG. 8, the communication device receives a vehicle control signal from a first user which is in a connected state and terminal positioned in a first area. The vehicle control signal may be a Bluetooth signal of the first user terminal, and a PEPS function may be performed through the vehicle control signal (S801).

Next, the processor is configured to search for a second user terminal which is in a registered state and positioned in a second area using a communication device (S802).

When the second user terminal is found in the second area, a processor is configured to obtain information related to the second user terminal positioned in the second area using the communication device (S803).

Next, the processor is configured to control a vehicle door to be unlocked according to the vehicle control signal of the first user terminal (S804).

Next, the processor is configured to perform the personalized linkage of the vehicle based on the information related to the second user terminal (S805).

Alternatively, when the processor does not find the registered second user terminal in the second area, the processor is configured to perform the personalized linkage of the vehicle based on information related to the first user terminal (S806).

Next, the processor initializes personalized linkage settings when the vehicle is turned off (S807).

FIG. 9 is a flowchart illustrating a method for controlling a vehicle according to another exemplary embodiment of the present disclosure. Referring to FIG. 9, a communication device receives a vehicle control signal from a first user terminal which is in a connected state and positioned in a first area (S901).

Next, a processor is configured to search for a second user terminal which is in a registered state and positioned in a second area using the communication device (S902).

When the second user terminal is found in the second area, the processor is configured to transmit a personalized linkage request message based on the second user terminal to the first user terminal through the communication device (S903).

Next, when receiving a personalized linkage permission message from the first user terminal, the processor is configured to obtain information related to the second user terminal positioned in the second area (S904 and S905).

Next, the processor is configured to control a vehicle door to be unlocked according to the vehicle control signal of the first user terminal (S906).

Next, the processor is configured to perform the personalized linkage of the vehicle based on the information related to the second user terminal (S907).

When the processor does not find the registered second user terminal in the second area or when the processor does not receive the personalized linkage permission message from the first user terminal, the processor is configured to perform the personalized linkage of the vehicle based on the information related to the first user terminal (S908).

Next, the processor initializes personalized linkage settings when the vehicle is turned off (S909).

FIG. 10 is a flowchart illustrating a method for controlling a vehicle according to yet another exemplary embodiment of the present disclosure. Referring to FIG. 10, a communication device receives a vehicle control signal from a first user terminal which is in a connected state and positioned in a first area (S1001).

Next, a processor is configured to search for a second user terminal which is in a registered state and positioned in a second area using the communication device (S1002).

When a plurality of registered second user terminals are found in the second area, the processor is configured to select one of the plurality of second user terminals and obtains information related to the terminal. For example, the processor is configured to select a second user terminal with the highest preset priority among the found second user terminals and obtains information related to the terminal. Alternatively, the second processing unit selects a second user terminal with the order of earliest registration among the second user terminals positioned in the second area and obtains information related to the terminal. Alternatively, the second processing unit selects a second user terminal closest to a driver's seat among the second user terminals positioned in the second area and obtains information related to the terminal (S1003 and S1004).

Next, the processor is configured to control a vehicle door to be unlocked according to the vehicle control signal of the first user terminal (S1005).

Next, the processor is configured to perform the personalized linkage of the vehicle based on the information related to the second user terminal (S1006).

Alternatively, when the processor does not find the registered second user terminal in the second area, the processor is configured to perform the personalized linkage of the vehicle based on information related to the first user terminal (S1007).

Next, the processor initializes personalized linkage settings when the vehicle is turned off (S1008).

FIG. 11 is a flowchart illustrating a method for controlling a vehicle according to yet another exemplary embodiment of the present disclosure. Referring to FIG. 11, a communication device receives a vehicle control signal from a first user terminal which is in a connected state and positioned in a first area (S1101).

Next, a processor is configured to search for a second user terminal which is in a registered state and positioned in a second area using the communication device (S1102).

When a plurality of registered second user terminals are found in the second area, the processor is configured to select one of the plurality of second user terminals. For example, the processor is configured to select a second user terminal with the highest preset priority among the plurality of found second user terminals. Alternatively, the second processing unit selects a second user terminal with the order of earliest registration among the second user terminals positioned in the second are Alternatively, the second processing unit selects a second user terminal closest to a driver's seat among the second user terminals positioned in the second area (S1103 and S1104).

Next, the communication device transmits a personalized linkage request message based on the selected second user terminal to a first user terminal (S1105).

Next, when receiving a personalized linkage permission message from the first user terminal, the processor is configured to obtain information related to the selected second user terminal (S1106 and S1107).

Next, when the processor does not receive the personalized linkage permission message from the first user terminal, the processor is configured to obtain information related to another one of the plurality of second user terminals. In the instant case, the selection method may be sequentially determined according to one of the above-described priority, registration order, or order of proximity to the driver's seat.

The processor repeats the above process until it receives the personalized linkage permission message for all the found second user terminals (S1108).

Next, the processor is configured to control a vehicle door to be unlocked according to the vehicle control signal of the first user terminal (S1109).

Next, the processor is configured to perform the personalized linkage of the vehicle based on the information related to the obtained second user terminal (S1110).

Alternatively, when the processor does not find the registered second user terminal in the second area or when the processor does not receive the personalized linkage permission message for all found second user terminals, the processor is configured to perform the personalized linkage of the vehicle based on information related to the first user terminal (S1111).

Next, the processor initializes personalized linkage settings when the vehicle is turned off (S1112).

The term “unit” used in an exemplary embodiment of the present disclosure means a software or hardware component such as a field-programmable gate array (FPGA) or an ASIC, and the “unit” is configured to perform certain roles. However, the “unit” is not limited to software or hardware. The “unit” may be disposed in an addressable storage medium and configured to reproduce one or more processors. Therefore, as an exemplary embodiment of the present disclosure, the “unit” is components such as software components, object-oriented software components, class components, and task components, processes, functions, attributes, procedures, subroutines, segments of program code, drivers, firmware, microcode, circuits, data, database, data structures, tables, arrays, and variables. Functions provided in the components and “units” may be combined into the smaller number of components and “unit” or separated into additional components and “units.” Additionally, the components and “units” may be implemented to reproduce one or more CPUs in a device or a security multimedia card.

A vehicle and a method for controlling the same according to various exemplary embodiments of the present disclosure, it is possible to perform personalized linkage by automatically recognizing a terminal positioned in a driver seat area.

Furthermore, it is possible to provide a PEPS function using a first connected smartphone and perform personalized linkage using another smartphone positioned at a driver's seat.

Furthermore, without disconnection of a first connected smartphone, it is possible to perform personalized linkage using another smartphone positioned at the driver's seat.

Furthermore, it is possible to perform personalized linkage using a smartphone adjacent to the driver's seat only when confirmation is performed by a smartphone in a connected state.

Furthermore, it is possible to perform personalized linkage by selecting one smartphone according to a preset criterion when a plurality of registered smartphones are found adjacent to the driver's seat.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the claims appended hereto and their equivalents.

What is claimed is:

1. A vehicle comprising:
at least one processor; and
a memory operatively connected to the at least one processor and configured to store one or more programs executed by the one or more processor,
wherein the at least one processor includes:
a first processing unit configured to search for a second user terminal which is in a registered state and positioned in a second area using a communication device in response to receiving a vehicle control signal from a first user terminal which is in a connected state and positioned in a first area through the communication device; and
a second processing unit configured to obtain information related to the second user terminal positioned in the second area through the communication device and perform personalized linkage of the vehicle based on the information related to the second user terminal.

2. The vehicle of claim 1, wherein the second processing unit is further configured to perform personalized linkage of the vehicle based on the first user terminal in response that the second processing unit does not find a user terminal in the second area.

3. The vehicle of claim 1, wherein the first area includes a wider radius range than the second area centered on the vehicle.

4. The vehicle of claim 3, wherein the first area is a passive entry operable area, and the second area is an area within less than or equal to a predetermined distance which is set in advance with respect to a driver's seat.

5. The vehicle of claim 1, further including:
a third processing unit configured to control an operation of the vehicle according to the vehicle control signal received from the first user terminal,
wherein the vehicle control signal includes a door control signal and a starting control signal.

6. The vehicle of claim 5, wherein the second processing unit is further configured to perform personalized linkage of the vehicle based on the second user terminal after the third processing unit unlocks a door of the vehicle according to the vehicle control signal.

7. The vehicle of claim 1, wherein, in response that the second user terminal in the registered state is found in the second area, the second processing unit transmits a personalized linkage request message based on the second user terminal to the first user terminal through the communication device.

8. The vehicle of claim 7, wherein the second processing unit is configured to perform personalized linkage of the vehicle based on the second user terminal in response to receiving a personalized linkage permission message from the first user terminal.

9. The vehicle of claim 1, wherein, in response that the second user terminal positioned in the second area is provided as a plurality of second user terminals, the second processing unit selects a second user terminal for personalized linkage according to a preset priority and is configured to perform personalized linkage of the vehicle.

10. The vehicle of claim 9, wherein the second processing unit sequentially transmits a personalized linkage request message based on the second user terminal to the first user terminal according to an order of the priority through the communication device.

11. The vehicle of claim 10, wherein, in response to receiving a personalized linkage permission message from the first user terminal, the second processing unit stops transmission of the personalized linkage request message.

12. The vehicle of claim 1, wherein the second processing unit initializes personalized linkage settings in response that the vehicle is turned off after performing personalized linkage of the vehicle based on the second user terminal.

13. A method for controlling a vehicle which is performed by a computing device including at least one processor and a memory operatively connected to the at least one processor and configured to store one or more programs executed by the at least one processor, the method comprising: by the at least one processor,
receiving a vehicle control signal from a first user terminal which is in a connected state and positioned in a first area through a communication device;
searching for a second user terminal which is in a registered state and positioned in a second area using the communication device;
obtaining information related to the second user terminal positioned in the second area through the communication device; and
performing personalized linkage of the vehicle based on the information related to the second user terminal.

14. The method of claim 13, further including, after searching for the second user terminal, performing personalized linkage of the vehicle based on the first user terminal in response that a user terminal is not found in the second area.

15. The method of claim 13, further including, before the performing of the personalized linkage of the vehicle, controlling an operation of the vehicle according to the vehicle control signal received from the first user terminal.

16. The method of claim 15, wherein the controlling of the operation of the vehicle includes controlling a door of the vehicle to be unlocked according to the vehicle control signal.

17. The method of claim 13, further including, before the performing of the personalized linkage of the vehicle, transmitting a personalized linkage request message based on the second user terminal to the first user terminal through the communication device.

18. The method of claim 17, wherein the performing of the personalized linkage of the vehicle includes:
receiving a personalized linkage permission message from the first user terminal through the communication device; and
performing personalized linkage of the vehicle based on the second user terminal according to the personalized linkage permission message.

19. A method for controlling a vehicle which is performed by a computing device including at least one processor and a memory operatively connected to the at least one processor and configured to store one or more programs executed by the at least one processor, the method comprising: by the at least one processor,
receiving a vehicle control signal from a first user terminal which is in a connected state and positioned in a first area through a communication device;
searching for a plurality of second user terminals that are in a registered state and positioned in a second area using the communication device;
selecting a second user terminal for personalized linkage among the plurality of second user terminals according to a preset priority;
obtaining information related to the selected second user terminal through the communication device; and
performing personalized linkage of the vehicle based on the information related to the second user terminal.

20. The method of claim 19, further including: before the performing of the personalized linkage of the vehicle,
sequentially transmitting a personalized linkage request message using the selected second user terminal to the first user terminal through the communication device; and
performing personalized linkage of the vehicle based on a corresponding second user terminal in response to receiving a personalized linkage permission message from the first user terminal.
